(19) United States
(12) Patent Application Publication
(10) Pub. No.: US 2011/0272210 A1
(43) Pub. Date: Nov. 10, 2011

(54) Ladder Safety Device

(76) Inventors: Robert F. Charlton, Pullenvale (AU); Craig R. Charlton, Brisbane (AU)

(21) Appl. No.: 13/184,520

(22) Filed: Jul. 16, 2011

Related U.S. Application Data
(62) Division of application No. 11/628,641, filed on Dec. 6, 2006.

(30) Foreign Application Priority Data
Jun. 17, 2005 (AU) PCT/AU2005/000861

(51) Int. Cl. E06C 7/18

(52) U.S. Cl. 182/107

(57) ABSTRACT

A ladder safety device (10) for stabilizing a ladder (11) leaning against a horizontal bead (14) of a gutter (15) secured adjacent the edge of a building, said safety device including a portable, hand-held, jaw-mounting body (19) having first and second jaw members (20 and 21) adapted, when the device is inoperative, to be spaced from one another, whereby the device may be brought to usage position and the body fitted over the bead (14) so that the bead is accommodated between the two jaw members. Actuating members (22) associated with said body cause closing together of the jaw members and effect clamping of the bead relative thereto, and, when the device is in use and said actuating means is rendered operative, ladder securing means (23) on the jaw-mounting body are adapted to be secured to the ladder to restrain relative motion between the ladder and the body.

### CROSS-REFERENCES TO RELATED APPLICATIONS

This application is a division of prior filed U.S. application Ser. No. 11/628,641, filed Dec. 6, 2006, which is in turn a national entry of prior filed PCT Application PCT/AU2005/000861, filed Jun. 17, 2005 and published Dec. 29, 2005 as WO 2005/124089. Both of these prior applications are incorporated by reference herein in their entirety.

### FIELD OF THE INVENTION

This Invention relates to an improved ladder safety device usable for holding a ladder in a safe and stable disposition while being used.

### BACKGROUND OF THE INVENTION

Many forms of apparatus and devices have been proposed in the past with a view to reducing accidents occasioned by lateral slippage of ladders placed so as to lean against buildings or other structures, especially against lengths of horizontal drainage guttering. A lengthy discussion on the danger factors is to be found in the specification of my International Patent Application No. PCT/AU02/00071 which is directed to the use of flexible connecting straps encircling ladder rungs and/or rails and having releasable engagement means securable where desired. Somewhat similar principles are illustrated in earlier patent specifications such as U.S. Pat. Nos. 4,924,971 to Rice and 4,545,460 to Byrd.

The present invention has been devised to provide a different approach to the problem of obtaining ladder stability, preferably without using flexible straps. Accordingly, its principal object is to provide a novel form of safety device which can be used more easily and positively than prior proposals, with cheapness and simplicity, yet proving highly efficient in operation. Other objects and advantages of the invention will hereinafter be apparent.

### SUMMARY OF THE INVENTION

Throughout the specification, my safety devices are described by way of example in the principal application in securing a ladder relative to continuous horizontal guttering at the edge of a building. Such guttering typically has an inner web, a floor, and an outer web, the latter terminating in a roll-formed bead which may be of desired form such as circular, triangular or square in cross-section or simply flanged. The words “bead of the type described” are used herein to embrace any such structure against which the ladder may be placed regardless of design. If desired, it could be any rail type member, with or without conventional types of guttering.

According to one aspect of the invention, there is provided a ladder safety device for stabilizing a ladder leaning against a horizontal bead of the type described, secured adjacent the edge of a building, said safety device including a portable, hand-held, jaw-mounting body having first and second jaw members adapted, when the device is inoperative, to be spaced from one another whereby the device may be brought to usage position and the body fitted over the bead so that the bead is accommodated between the two jaw members, actuating means associated with said body and adapted to be manually actuated to cause closing together of the jaw members and effect clamping of the bead relative thereto, and ladder securing means on the jaw-mounting body and adapted to be secured to the ladder to restrain relative motion between the ladder and the body when the device has been brought to usage position and said actuating means has been rendered operative.

In a preferred embodiment, the jaw-mounting body includes a lower body portion on which said first jaw member is mounted substantially fixedly but adapted to be adjustably set in selected position beneath and outwardly of said bead.

Preferably also, the jaw-mounting body includes an upper body portion on which said second jaw member is mounted for pivotal movement about a horizontal axis between said raised inoperative positions spaced from the first jaw member and a lower clamping position in which it co-acts with the first jaw member and is disposed inwardly of said bead. Suitably, ‘pivotal movement of the second jaw member is effected by a handle member pivotally connected thereto about a horizontal axis, the parts being so made and arranged that the handle is pivotally raised when the jaw members are spaced and inoperative but is swung down to a lower operative position adjacent the first jaw member when clamping is effected.

According to another preferred feature, locking means are provided to secure the second jaw member in its clamping position when the actuating means have been operated.

Suitably, the locking means includes an over-centre locking arrangement of the toggle-locking type adapted to hold the jaw members effective until the actuating means are released. In most instances, the jaw members are designed to effect clamping on opposite sides of an outer upwardly-extending gutter web having its top edge formed into said bead so that the web will be gripped closely below said bead.

According to another preferred feature, the jaw-mounting body is constituted by two side-by-side portions joined about a vertical joint, the upper ends having pivot mountings for the pivoted second jaw member. Suitably, said vertical joint of the side-by-side body portions acts as a guide for a vertically adjustable mounting for the first jaw member. Suitably also, the first jaw member has a guide bolt passing through said vertical joint and spring-loaded so that it is digitally slidable to selected vertical position. It is preferred that the co-acting faces of the two jaw members are each fitted with a hard rubber or the like facing strip.

In a preferred embodiment, a quick-release trigger mechanism is provided for release of the actuating means when the latter is locked in a lamping position. Suitably, the quick-release trigger has at its lower end a locking lug that is engagable in said vertical joint in an aperture between said side-by-side portions.

In a preferred embodiment, the ladder securing means includes a locking bar hinged to the jaw-mounting body and adapted to fit snugly there-against when not in use, but able to swivel and to be movable releasably to and around a side rail of a ladder located beside the device when the device is in use. Preferably, the locking bar is mounted for connection to a ladder at either side of the device when in use. In an alternative preferred embodiment, the ladder securing means includes a locking bar which passes through holes on the top of the jaw-mounting body, being able to extend out via a controlled extension mechanism e.g. a spring activated locking device or a ratchet type mechanism, able to swivel around a side rail of a ladder located beside the device when the device is in use.

As a further feature, the handle member for actuating the clamping jaw member is also designed for use in carrying the device between usage locations. Other features of the invention are hereinafter described.

### BRIEF DESCRIPTION OF THE DRAWINGS

In order that the invention may be more readily understood and put into practical effect, reference will now be made to the accompanying drawings wherein:

FIG. 1 is a perspective view of a preferred embodiment of a ladder safety device according to the present invention, shown attached to a ladder, and shown in a preliminary inoperative attitude prior to use;

FIG. 2 shows in side elevation the device illustrated in FIG. 1, again in the attitude prior to use;

FIG. 3 is a side elevation corresponding to FIG. 2 but with the actuating means operated so that the jaws are in clamping positions as in use;

FIG. 4 shows the components in the same attitudes as in FIG. 3, but as a perspective view similar to FIG. 1;

FIG. 5 is another perspective view similar to FIG. 4 but taken from the opposite side of the ladder and device; and

FIG. 6 shows a front elevation of the alternative locking bar passing through holes on top of the jaw-mounting body.

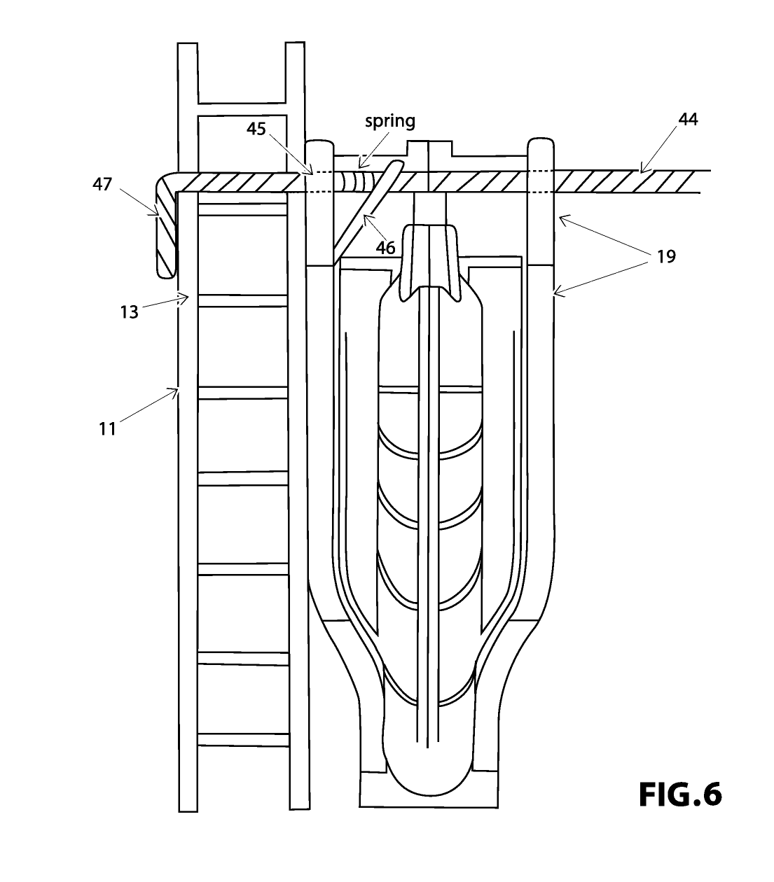

### DETAILED DESCRIPTION OF THE DRAWINGS

As shown in the drawings, the device indicated generally at 10 is for use in stabilizing a ladder 11 having horizontal 10 rungs 12 and vertical rails 13. In this instance, the ladder 11 is leaning against a horizontal bead 14 of a gutter 15 at the edge of an outer upwardly-extending gutter web 16 integral with a gutter floor 17 and inner web 18 by which the gutter 15 is secured to a building (not shown).

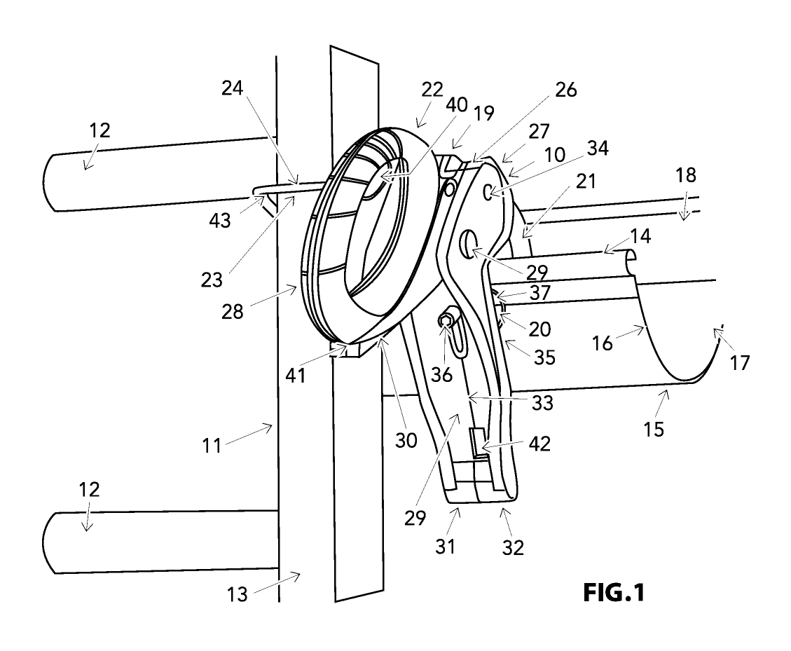

It will be seen that the device 10 includes a portable, hand-held, jaw-mounting body 19 having first and second jaw members 20 and 21 adapted, when the device is inoperative, to be spaced from one another as shown in FIGS. 1 & 2, whereby the device may be brought to usage position and the body 19 fitted over the bead 14 so that the bead is accommodated between the two jaw members.

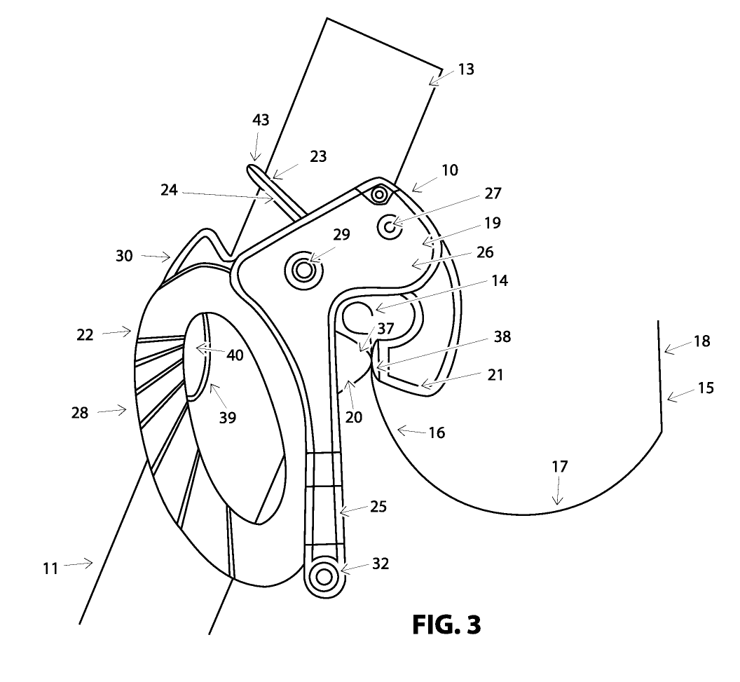

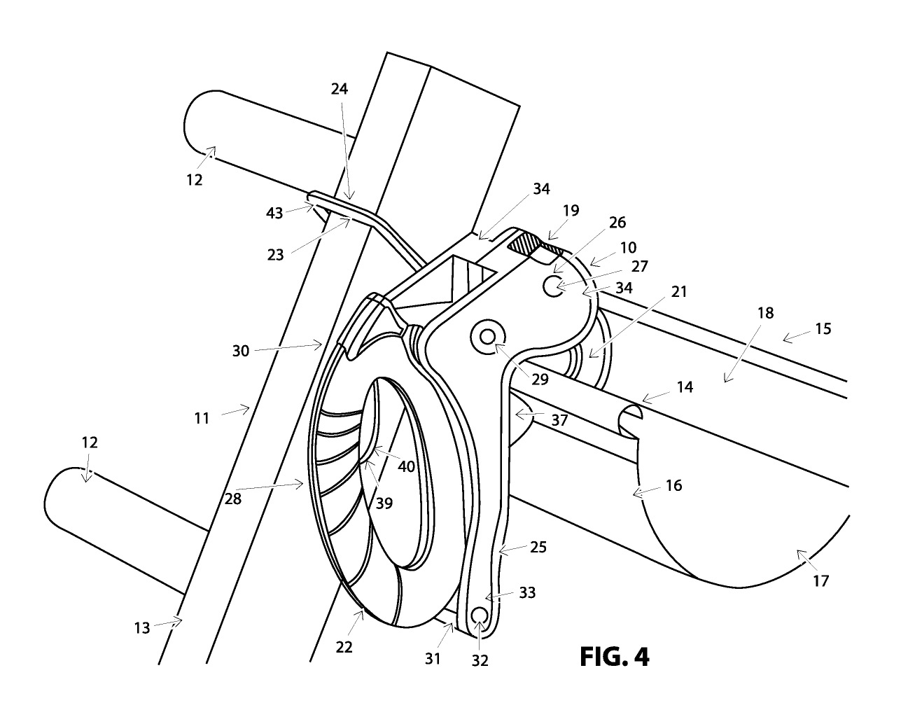

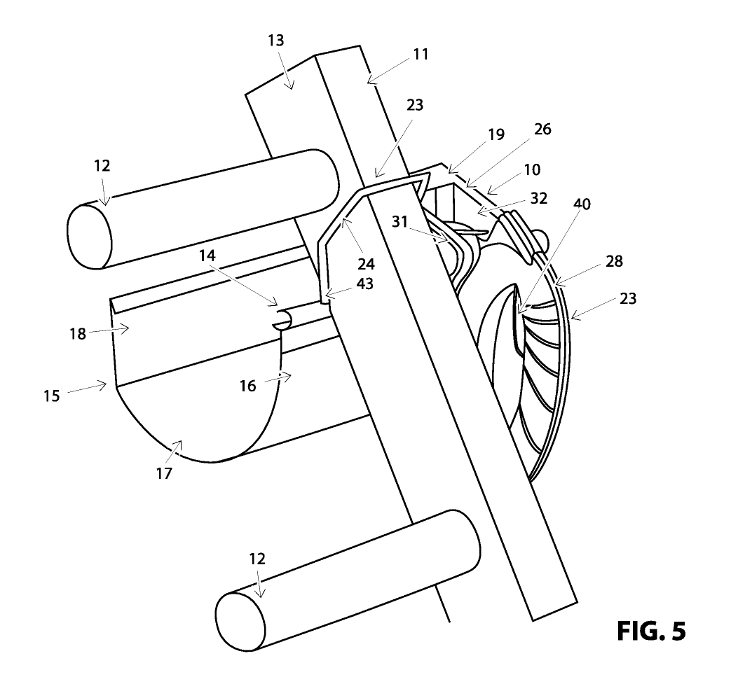

Actuating means indicated generally at 22 are associated with said body 19 and are adapted to be manually actuated to cause closing together of the two jaw members 20 and 21 and 25 effect clamping of the bead 14 relative thereto. Ladder securing means indicated generally at 23 are provided on the jaw-mounting body 19 and adapted to be secured to the ladder 11 at 24 to restrain relative motion between the ladder and the body 19 when the device 10 has been brought to usage position and said actuating means 22 has been rendered operative as apparent from FIGS. 3 to 5.

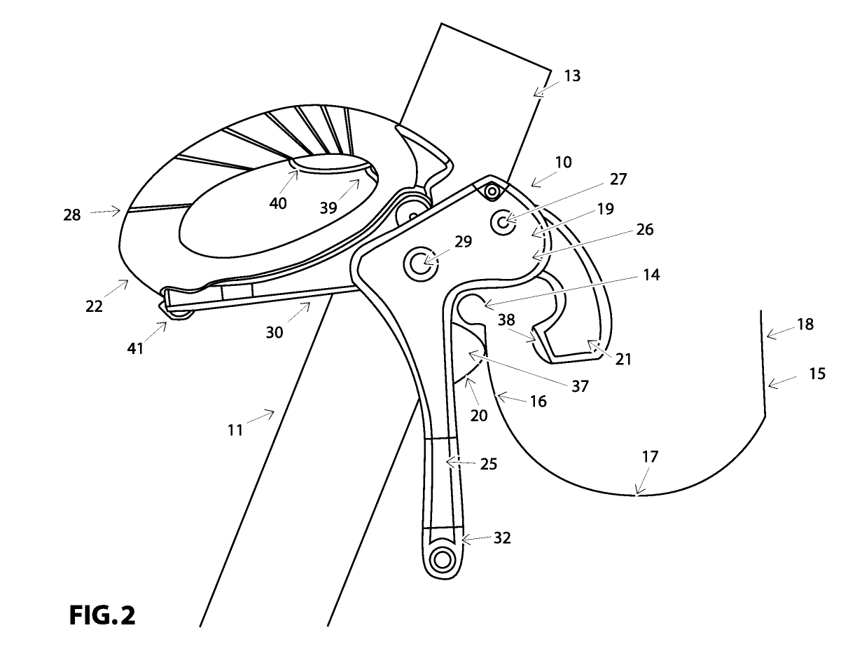

It will be seen that the jaw-mounting body 19. includes a lower body portion 25 on which said first jaw member 20 is mounted substantially fixedly but adapted to be adjustably set in selected position beneath and outwardly of the bead 14 as best shown in FIG. 2. The jaw-mounting body 19 includes also an upper body portion 26 on which the second jaw member 21 is mounted for pivotal movement about a horizontal axis 27 between the raised, inoperative positions spaced from the first jaw member 20 and a lower clamping position as shown in FIG. 3 in which it co-acts with the first jaw member 20 and is disposed inwardly of the bead 14.

It will be seen that pivotal movement of the second jaw member 21 is effected by a handle member 28 pivotally connected thereto about a horizontal axis 29. By comparing FIGS. 2 and 3, it will be noted that the handle 28 is pivotally raised when the jaw members are spaced and inoperative but is swung down to a lower operative position adjacent to the first jaw member 20 when clamping is effected.

Locking means indicated generally at 30 are provided to secure the second jaw member 21 in its clamping position when the actuating means 22 have been operated. The locking means 30 include linkages, pivots and levers between the handle 28 and second jaw 21 to provide an over-centre arrangement of the toggle-locking type adapted to hold the jaw members effective until the actuating means are released. The locking means includes a further pivot (not shown) between the upper components so that a “past dead centre” toggle action can be obtained.

As shown in FIGS. 2 and 3, the jaw members 20 and 21 are designed to effect clamping on opposite sides of the outer, upwardly-extending gutter web 16 which has the said bead 14 at its top. Most desirably, the web 16 will be gripped closely below said bead 14 as shown in FIG. 3 the jaw-mounting body 19 will be seen to be constituted by two side-by-side portions 31 and 32 joined about a vertical joint 33, the upper ends having pivot mountings 34 for the pivoted second jaw member 21.

It will be seen from FIG. 1 that the vertical joint 33 of the side-by-side body portions 31 and 32 acts as a guide for a vertically adjustable mounting 35 for the first jaw member 20. In this regard, the first jaw member 20 has a guide bolt 36 passing through said vertical joint 33 and spring-loaded (not shown) so that it is digitally slidable to selected vertical position. It will also be noted that the co-acting faces 37 and 38 of the two jaw members are fitted with facing strips suitably of hard rubber or the like.

A feature of the invention is the provision of a quick-release trigger mechanism 39 for release of the actuating means 22 when the latter is locked in a clamping position. The quick-release trigger 40 will be seen to be connected by linkage on the handle 28 to a lower locking lug 41 of hooked form engagable in the vertical joint 33 in a shouldered aperture 42 defined between the side-by-side portions 31 and 32.

Also, the ladder-securing means 23 includes a locking bar 43 hinged to the jaw-mounting body 19 and fitting snugly against it when not in use, but able to swivel and to be movable releasably to and around the side rail 13 of the ladder 11 located beside the device when the device is in use. As a simple design feature, the locking bar 43 is mounted for connection to the ladder 11 when the device 10 is at either side thereof. As will be apparent, the handle member 28 for actuating the clamping jaw member 21 is also designed for use in carrying the device between usage locations.

Also the ladder-securing means includes an alternative locking bar 44 which passes through securing holes 45 on the top of the jaw-mounting body 19. There is a spring activated locking device 46, through which the locking bar 44 passes.

When compressed this spring activated locking device 46 allows the locking bar 44 to slide through and extend or retract to the correct length to allow it to fit securely around the side rail 13 of the ladder 11. When the locking bar 47 fits snugly around the side rail of the ladder, the spring activated locking device 46 is released to lock the locking bar 44 in that position, thus locking the ladder against the device. The spring activated locking device 46 could also be replaced by a ratchet type mechanism which would utilize teeth in the locking bar 44, allowing the mechanism to lock the locking bar 44 in position at the required position.

The manner of using the device 10 will be clear from the drawings and preceding descriptions but in any event is self-evident. The device is light in weight and readily portable in a hand-held manner, and its compactness affords simple and safe movements at all times. The single handle is used initially for carrying the device, and then for putting it in the appropriate usage location over the bead, and then for effecting clamping and automatic locking in a past-dead-centre toggle action, similar to a louver window handle action. The locking bar is simple but effective, and the locking components have rigidity over an adequate length along the bead and guttering so that stability and safety are achieved. While devices as described and illustrated will be found very effective in achieving the objects for which the invention has been devised, it will be understood that the embodiment described is illustrative only and may be subject to many modifications of constructional detail and design, as will be readily apparent to persons skilled in the art and without departing from the broad scope and ambit of the invention as defined by the appended claims.

I claim:

1. For use with a ladder having two parallel side rails, a ladder safety device for stabilizing said ladder when the ladder leans against a horizontal bead, the bead being secured adjacent an edge of a building, said safety device comprising:
a. a portable, hand-held, jaw-mounting body having two lateral sides and first and second jaw members extending towards a front of the jaw mounting body, at least one of said first and second jaw members being movable in reference to the other such that the first and second jaw members are capable of transition between an open configuration and a closed configuration, wherein, while in the open configuration, the first and second jaw members are adapted to be spaced from one another and the ladder safety device is then capable of being brought to a usage position by the body being fitted over the bead so that the bead is accommodated between the two jaw members and, while in the closed configuration, the first and second jaw members are adapted to effect clamping of the bead;
b. means for transitioning the jaw members between the open and the closed configurations; and
c. a removable locking bar extending through an upper portion of the jaw mounting body and being laterally extensible and retractable with respect to the jaw-mounting body.

2. The ladder safety device according to claim 1, wherein said jaw mounting body includes a lower body portion on which said first jaw member is mounted substantially fixedly but adapted to be adjustably set in a selected position beneath and outwardly of said bead.

3. The ladder safety device according to claim 2, wherein said jaw-mounting body includes an upper body portion on which said second jaw member is mounted for pivotal movement about a horizontal axis between the open configuration and the closed configuration in which the second jaw member is disposed inwardly of said bead.

4. The ladder safety device according to claim 3, wherein pivotal movement of the second jaw member is effected by a handle member pivotally connected thereto about a horizontal axis, the second jaw member and jaw-mounting body being so made and arranged that the handle is pivotally raised when the first and second jaw members are in the open configuration but is swung down to a lower position, adjacent the first jaw member, in order to pivot the second jaw member such that the first and second jaw members are in the closed position.

5. The ladder safety device according to claim 4, wherein locking means are provided to secure the second jaw member in the closed position when the actuating means has been operated.

6. The ladder safety device according to claim 5, further comprising an over-center locking arrangement of the toggle-locking type adapted to hold the jaw members effective until the actuating means are released.

7. The ladder safety device according to claim 6, wherein the jaw members are designed to effect clamping on opposite sides of an outer upwardly-extending gutter web having a top edge formed into said bead so that the web will be gripped closely below said bead.

8. The ladder safety device according to claim 6, jaw-mounting body further comprising two side-by-side portions joined about a vertical joint, upper ends of said portions having pivot mountings for the second jaw member.

9. The ladder safety device according to claim 8, wherein said vertical joint of the side-by-side body portions acts as a guide for a vertically adjustable mounting for the first jaw member.

10. The ladder safety device according to claim 9, wherein the first jaw member further comprises a spring-loaded guide bolt passing through said vertical joint such that the guide bolt is slidable to a selected vertical position.

11. The ladder safety device according to claim 8, further comprising elastomeric strips fitted upon each of opposing faces of the two jaw members.

12. The ladder safety device according to claim 1, further comprising a quick-release trigger mechanism for release of the means for transitioning the jaw members.

13. The ladder safety device according to claim 12, wherein the quick-release trigger further comprises a locking lug positioned at a lower end of said quick-release trigger and being engagable in said vertical joint in an aperture between said side-by-side portions.

14. For use with a ladder having two parallel side rails, a ladder safety device for stabilizing a ladder while the ladder against a horizontal bead, the bead being secured adjacent an edge of a building, said safety device comprising:
a. a portable, hand-held, jaw-mounting body having two lateral sides and first and second jaw members, at least one of said first and second jaw members being movable in reference to the other such that the first and second jaw members are capable of transition vertically between an open and a closed configuration, wherein, while in the open configuration, the first and second jaw members are adapted to be spaced from one another and the ladder safety device is then capable of being brought to a usage position by the body being fitted over the bead so that the bead is accommodated between the two jaw members and, while in the closed configuration, the first and second jaw members are adapted to effect clamping of the bead;
b. means for transitioning the jaw members between the open and the closed configurations; and
c. a locking bar passing laterally through an upper portion of the jaw-mounting body and defining a horizontal direction, said locking bar being both extensible and retractable in both the horizontal direction and in a direction normal to the horizontal direction in a manner to allow the locking bar to engage either one of the side rails of the ladder.
